(19) United States
(12) Patent Application Publication
(10) Pub. No.: US 2023/0382143 A1
(43) Pub. Date: Nov. 30, 2023

(54) PRINTING DEVICE AND PRINTING SYSTEM

(71) Applicant: SEIKO EPSON CORPORATION, Tokyo (JP)

(72) Inventors: Atsuyuki IMAIZUMI, Shiojiri (JP); Ryu KAMEI, Matsumoto (JP); Shinichi YOSHIE, Tatsuno-machi (JP)

(21) Appl. No.: 18/321,922

(22) Filed: May 23, 2023

(30) Foreign Application Priority Data
May 25, 2022 (JP) 2022-085076

(51) Int. Cl. B41J 29/393

(52) U.S. Cl. CPC B41J 29/393

(57) ABSTRACT

A printing device includes a first coupling section to which a first cable configured to transmit information and transmit electric power is coupled and a printing section that executes print processing of forming an image based on information supplied from the first cable on a medium using electric power supplied from the first cable.

The present application is based on, and claims priority from JP Application Serial Number 2022-085076, filed on May 25, 2022, the disclosure of which is hereby incorporated by reference herein in its entirety.

### BACKGROUND

### 1. Technical Field

The present disclosure relates to a printing device and a printing system.

### 2. Related Art

Printing devices that form an image on a medium have been widely used. For example, in JP-A-2018-163390, a printing device that executes print processing of forming an image on a medium using electric power supplied from an external power source, such as a commercial AC power or the like, is described.

However, when the printing device receives supply of electric power from an external power source, it is required to couple a plurality of wirings, that is, an information supply wiring used for supplying information to the printing device from an information processing device, such as a host computer or the like, and a power supply wiring used for supplying electric power to the printing device from the external power source, to the printing device, and a problem arises in which the number of wirings coupled to the printing device is increased.

### SUMMARY

In order to solve the above-described problem, a printing device according to the present disclosure includes a first coupling section to which a first cable configured to transmit information and transmit electric power is coupled and a printing section that executes print processing of forming an image based on information supplied from the first cable on a medium using electric power supplied from the first cable.

A printing system according to the present disclosure includes a printing device including a first coupling section to which a first cable configured to transmit information and transmit electric power is coupled, a second coupling section to which a second cable configured to transmit information and transmit electric power is coupled, and a printing section that executes print processing of forming an image based on information supplied from the first cable on a medium using electric power supplied from the first cable, and an external device that is coupled to the printing device via the second cable, and the printing device supplies electric power to the external device via the second cable.

### BRIEF DESCRIPTION OF THE DRAWINGS

FIG. 1 is a block diagram illustrating an example of a configuration of a printing system according to an embodiment of the present disclosure.

FIG. 2 is a block diagram illustrating an example of a configuration of a printing device.

FIG. 3 is a block diagram illustrating an example of a configuration of a power supply unit.

FIG. 4 is a perspective view illustrating an example of a schematic internal structure of the printing device.

FIG. 5 is a cross-sectional view illustrating an example of a structure of an ejection section.

FIG. 6 is a block diagram illustrating an example of a configuration of a head unit.

FIG. 7 is a timing chart illustrating an example of a signal supplied to the head unit.

FIG. 8 is a table illustrating an example of an individual designation signal.

FIG. 9 is a block diagram illustrating an example of a configuration of a printing system according to a first modified example of the present disclosure.

FIG. 10 is a block diagram illustrating an example of a configuration of a printing device according to the first modified example.

FIG. 11 is a block diagram illustrating an example of a configuration of a power supply unit according to the first modified example.

### DESCRIPTION OF EXEMPLARY EMBODIMENTS

An embodiment of the present disclosure will be described below with reference to the accompanying drawings. However, in each of the drawings below, dimensions and a scale of each part are different from actual ones as appropriate. The embodiment described below is a preferable concreate example of the present disclosure, and therefore, has various kinds of technically preferred limitations. The scope of the present disclosure, however, is not limited to such embodiments unless there is any description specifically limiting the present disclosure in the following description.

### A. Embodiment

In this embodiment, a printing system Sys including a printing device 1 that ejects ink to form an image on recording paper PP will be described.

### 1. Outline of Printing System

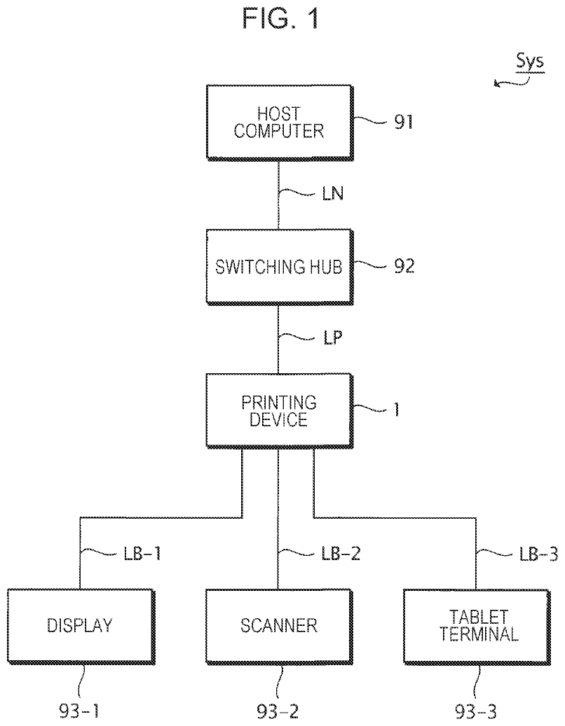

An example of a configuration of the printing system Sys according to this embodiment will be described below with reference to FIG. 1.

FIG. 1 a functional block diagram illustrating an example of a configuration of the printing system Sys.

As illustrated in FIG. 1, the printing system Sys includes the printing device 1, a host computer 91, a switching hub 92 that couples the printing device 1 and the host computer 91, a cable LN that couples the host computer 91 and the switching hub 92, and a cable LP that couples the switching hub 92 and the printing device 1.

The cable LP is a wired LAN cable conforming to an IEEE 802.3 standard related to Ethernet (registered trademark). In this embodiment, it is assumed that the cable LP is a wired LAN cable conforming to a PoE standard, such as IEEE 802.3af, IEEE 802.3at, IEEE 802.3bt, or the like. As used herein, the term “LAN” is an abbreviation for Local Area Network. That is, the cable LP is an example of a “first cable” configured to both transmit information and transmit electric power.

The switching hub 92 is a switching hub conforming to a PoE standard. As used herein, the term “PoE” is an abbreviation for Power over Ethernet. In this embodiment, the switching hub 92 supplies electric power to the printing device 1 via the cable LP.

The cable LN is a wired LAN cable conforming to an Ethernet standard. Note that the cable LN may be a wired LAN cable conforming to the PoE standard.

The host computer 91 is, for example, a personal computer, a digital camera, or the like and stores image data Img indicating an image that the printing device 1 is to form. The host computer 91 communicates with the printing device 1. Specifically, the host computer 91 transmits various types of information, such as the image data Img or the like to the printing device 1 via the cable LN, the switching hub 92, and the cable LP. The host computer 91 acquires various types of information from the printing device 1 via the cable LN, the switching hub 92, and the cable LP.

Note that, in this embodiment, description is given using as an example a case where the host computer 91 and the switching hub 92 are coupled via the cable LN that is a wired LAN cable, but the present disclosure is not limited thereto. The host computer 91 and the switching hub 92 may be coupled via some other wired network than a LAN, and may be coupled via a wireless network. Moreover, various network devices, such as a switching hub, a router, or the like may be provided between the host computer 91 and the switching hub 92.

The printing system Sys includes one or more external devices 93 and one or more cables LB corresponding to the one or more external devices 93 on a one-to-one basis. In this embodiment, as an example, a case where the printing system Sys includes three external devices 93 and three cables LB is assumed. Specifically, in this embodiment, as an example, a case where the three external devices 93 provided in the printing system Sys are a display 93-1, a scanner 93-2, and a tablet terminal 93-3 is assumed. In this embodiment, the cable LB that couples the printing device 1 and the display 93-1 will be referred to as a cable LB-1, the cable LB that couples the printing device 1 and the scanner 93-2 will be referred to as a cable LB-2, and the cable LB that couples the printing device 1 and the tablet terminal 93-3 will be referred to as a cable LB-3.

Note that the cable LB is a cable conforming to a USB standard. As used herein, the term “USB” is an abbreviation for Universal Serial Bus. That is, the cable LB is an example of a “second cable” configured to both transmit information and supply electric power. In this embodiment, the printing device 1 supplies electric power to the external device 93 via the cable LB. The printing device 1 transmits various types of information to the external device 93 via the cable LB. The printing device 1 acquires various types of information from the external device 93 via the cable LB.

### 2. Outline of Printing Device

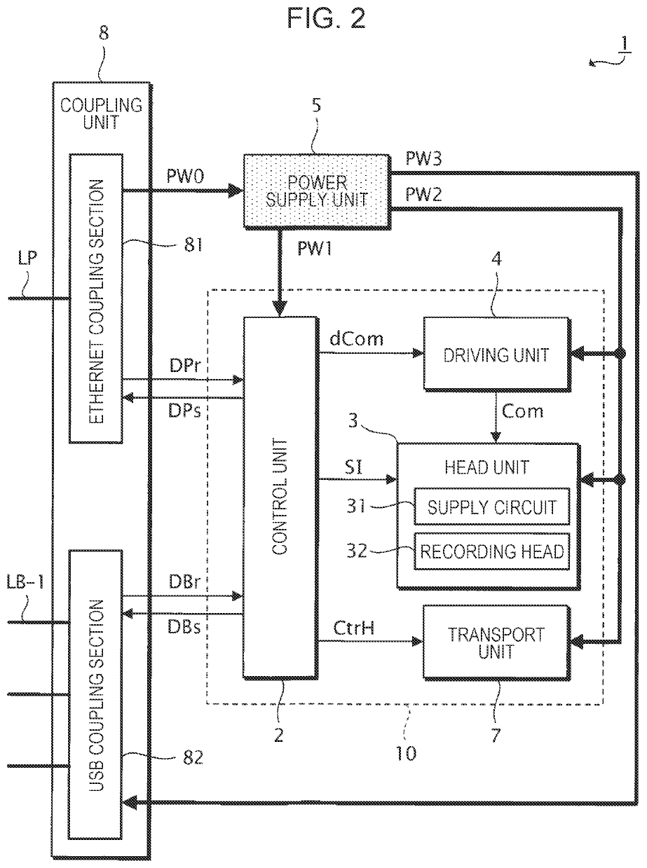

An example of a configuration of the printing device 1 according to this embodiment will be described below with reference to FIG. 2 to FIG. 5.

FIG. 2 is a functional block diagram illustrating an example of a configuration of the printing device 1.

As illustrated in FIG. 2, the printing device 1 includes a print processing execution section 10 that executes pint processing of forming an image on the recording paper PP, based on the image data Img supplied from the host computer 91, a power supply unit 5 that supplies electric power to the print processing execution section 10, and a coupling unit 8 that couples the cable LP and the cables LB to the printing device 1. Of the above-described components, the print processing execution section 10 includes a control unit 2 that controls each component of the printing device 1, a head unit 3 in which an ejection section D that ejects ink to the recording paper PP is provided, a driving unit 4 that generates a driving signal Com to drive the ejection section D, and a transport unit 7 that changes a relative position of the recording paper PP with respect to the head unit 3.

Note that the recording paper PP is an example of a “medium,” the print processing execution section 10 is an example of a “printing section,” the control unit 2 is an example of a “control section,” and the head unit 3 is an example of an “image forming section.”

In this embodiment, a case where the printing device 1 includes one or more head units 3 and one or more driving signal generation units 4 corresponding to the one or more head units 3 on a one-to-one basis is assumed. Specifically, in this embodiment, a case where the printing device 1 includes four head units 3 and four driving signal generation units 4 corresponding to the four head units 3 on a one-to-one basis is assumed. However, in the following, for convenience, as illustrated in FIG. 2, description is sometimes made with focus on one head unit 3 of the four head units 3 and one driving unit 4 of the four driving units 4 that is provided to correspond to the one head unit 3.

The control unit 2 includes one or more CPUs. However, the control unit 2 may include, instead of the one or more CPUs or in addition to the one or more CPUs, a programmable logic device, such as a FPGA or the like. As used herein, the term “CPU” is an abbreviation for central processing unit, and the term “FPGA” is an abbreviation for field-programmable gate array. The control unit 2 includes memory. The memory includes one or both of volatile memory, such as random access memory (RAM) or the like, and nonvolatile memory, such as read only memory (ROM), electrically erasable programmable read-only memory (EEPROM), programmable ROM (PROM), or the like.

Although details will be described later, the control unit 2 generates signals, such as a print signal SI, a waveform designation signal dCom, or the like, that control an operation of each component of the printing device 1.

As used herein, the term “waveform designation signal dCom” refers to a digital signal that defines a waveform of a driving signal Com. The term “driving signal Com” refers to an analog signal that drives the ejection section D. The driving unit 4 includes a DA conversion circuit and generates the driving signal Com having a waveform defined by the waveform designation signal dCom. The print signal SI is a digital signal that designates a type of an operation of the ejection section D.

Specifically, the print signal SI is a signal that designates a type of an operation of the ejection section D by designating whether to supply the driving signal Com to the ejection section D.

The head unit 3 includes a supply circuit 31 and a recording head 32.

The recording head 32 includes M ejection sections D. Herein, a value M is a natural number that satisfies “M≥1.” Note that, in the following, among the M ejection sections D provided in the recording head 32, an mth ejection section D will be sometimes referred to as an ejection section D[m]. Herein, a variable m is a natural number that satisfies “1≤m≤M.” In the following, when a component element of the printing device 1, a signal, or the like corresponds to the ejection section D[m] among the M ejection sections, a suffix [m] is sometimes attached to a sign representing the component element, the signal, or the like.

The supply circuit 31 switches, based on the print signal SI, whether the driving signal Com is supplied to the ejection section D[m]. Note that, among the driving signals Com, a driving signal Com supplied to the ejection section D[m] will be hereinafter sometimes referred to as a supply driving signal Vin[m].

As described above, in this embodiment, the printing device 1 executes print processing. When the print processing is executed, the control unit 2 generates a signal, such as the print signal SI or the like, that controls the head units 3, based on the print data Img. When the print processing is executed, the control unit 2 generates a signal, such as the waveform designation signal dCom or the like, that controls the driving unit 4. Moreover, when the print processing is executed, the control unit 2 generates a control signal CtrH that controls the transport unit 7. Thus, in the print processing, the control unit 2 controls the components of the printing device 1 to adjust whether to eject ink from the ejection section D[m], an ink ejection amount, an ink ejection timing, or the like such that an image corresponding to the print data Img is formed on the recording paper PP, while controlling the transport unit 7 to change the relative position of the recording paper PP with respect to the head unit 3.

The coupling unit 8 includes an Ethernet coupling section 81 coupled to the cable LP and a USB coupling section 82 coupled to the cables LB.

The Ethernet coupling section 81 divides signals supplied from the cable LP into electric power PW0 and reception information DPr. The Ethernet coupling section 81 supplies the electric power PW0 to the power supply unit 5 and supplies the reception information DPr to the control unit 2. Herein, the electric power PW0 is electric power of a voltage V0 supplied from the cable LP. Herein, the voltage V0 is, for example, 30 V. The reception information DPr is information supplied from the cable LP and, for example, includes the image data Img.

Moreover, transmission information DPs is supplied to the Ethernet coupling section 81 from the control unit 2. Then, the Ethernet coupling section 81 outputs the transmission information DPs to the cable LP. Note that the Ethernet coupling section 81 is an example of a “first coupling section.”

In this embodiment, the print processing execution section 10 executes print processing using information, such as the image data Img included in the reception information DPr supplied from the cable LP or the like. In this embodiment, the print processing execution section 10 executes print processing using the electric power PW0 supplied from the cable LP. That is, in this embodiment, the print processing execution section 10 is configured to execute print processing in a state where the cable LP is coupled to the printing device 1 and a state where no cable other than the cable LP is coupled to the printing device 1.

The USB coupling section 82 supplies reception information DBr supplied from the cable LB to the control unit 2. The USB coupling section 82 outputs transmission information DBs supplied from the control unit 2 to the cable LB. Although details will be described later, electric power PW3 of a voltage V3 is supplied to the USB coupling section 82 from the power supply unit 5. The USB coupling section 82 supplies the electric power PW3 supplied from the power supply unit 5 to the external devices 93 via the cables LB. Note that the USB coupling section 82 is an example of a “second coupling section.”

Note that, in this embodiment, the control unit 2 may be configured to control the external device 93 in accordance with the transmission information DBs supplied to the external device 93 via the cable LB. In this embodiment, the control unit 2 may be configured to supply the reception information DBr acquired from the external device 93 via the cable LB to the host computer 91 via the cable LP.

Based on the electric power PW0 of the voltage V0 supplied from the cable LP, the power supply unit 5 supplies electric power PW1 of a voltage V1 to the control unit 2, supplies electric power PW2 of a voltage V2 to the head unit 3, the driving unit 4, and the transport unit 7, and supplies the electric power PW3 of the voltage V3 to the USB coupling section 82.

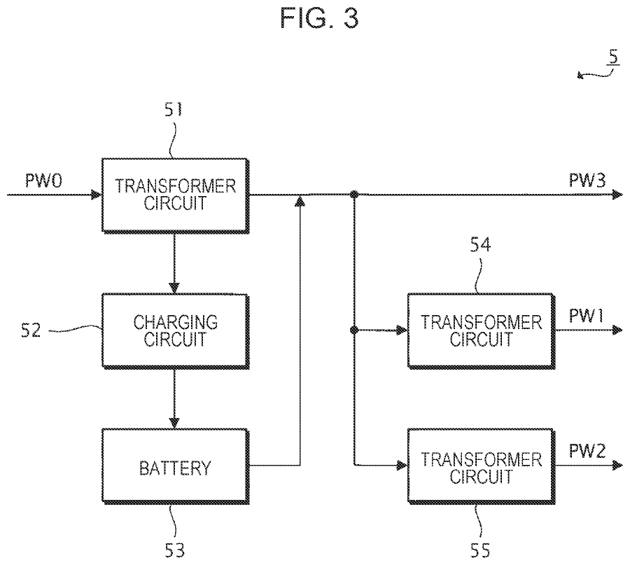

FIG. 3 is a functional block diagram illustrating an example of a configuration of the power supply unit 5.

As illustrated in FIG. 3, the power supply unit 5 includes a transformer circuit 51, a charging circuit 52, a battery 53, a transformer circuit 54, and a transformer circuit 55.

The transformer circuit 51 convers the voltage V0 of the electric power PW0 supplied from the cable LP via the Ethernet coupling section 81 to the voltage V3 and outputs the electric power PW3 of the voltage V3. Herein, the voltage V3 is, for example, 5 V.

The charging circuit 52 charges the battery 53 using the electric power PW3 of the voltage V3 output from the transformer circuit 51. Note that the charging circuit 52 may be configured to charge the battery 53 using the electric power PW0 of the voltage V0 supplied from the Ethernet coupling section 81.

The battery 53 outputs the electric power PW3 of the voltage V3 using electric power charged to the battery 53. The electric power PW3 output from the transformer circuit 51 or the battery 53 is supplied to the external device 93 via the USB coupling section 82 and the cable LB. The external device 93 is driven by the electric power PW3 supplied from the power supply unit 5 via the cable LB.

The transformer circuit 54 converts the voltage V3 of the electric power PW3 suppled from the transformer circuit 51 or the battery 53 to the voltage V1 and outputs the electric power PW1 of the voltage V1. Herein, the voltage V1 is, for example, 3.3 V. The electric power PW1 output from the transformer circuit 54 is supplied to the control unit 2.

The transformer circuit 55 converts the voltage V3 of the electric power PW3 supplied from the transformer circuit 51 or the battery 53 to the voltage V2 and outputs the electric power PW2 of the voltage V2. Herein, the voltage V2 is, for example, 24V. The electric power PW2 output from the transformer circuit 55 is supplied to the head unit 3, the driving unit 4, and the transport unit 7. That is, the print processing execution section 10 executes print processing using the electric power PW1 and the electric power PW2 supplied from the power supply unit 5.

Note that, in this embodiment, the power supply unit 5 including the battery 53 is an example of a “power storage section.”

In this embodiment, the control unit 2 may be configured to adjust a magnitude of the electric power PW3 supplied to the external device 93 from the power supply unit 5 via the cable LB in accordance with a type of the external device 93. The power supply unit 5 may be configured to supply the electric power PW3 having a magnitude in accordance with the type of the external device 93 to the external devices 93 via the cable LB.

For example, the control unit 2 may be configured to acquire information related to a necessary amount of electric power in the external device 93 via the cable LB from the external device 93 and generate electric power information related to the magnitude of the electric power PW3, based on the acquired information. For example, the electric power information may be information indicating the voltage V3. In this case, the transformer circuit 51 may be configured to output the electric power PW3 of the v3 defined in accordance with the electric power information.

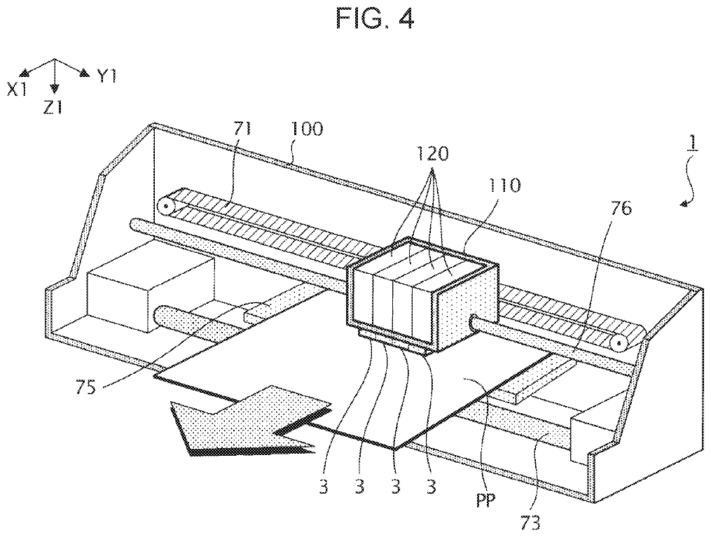

FIG. 4 is a perspective view illustrating an example of a schematic internal structure of the printing device 1.

As illustrated in FIG. 4, in this embodiment, a case where the printing device 1 is a serial printer is assumed. Specifically, in executing print processing, while transporting the recording paper PP in an X1 direction, the printing device 1 ejects ink from the ejection section D[m] with the head unit 3 reciprocated in a Y1 direction crossing the X1 direction and a Y2 direction that is an opposite direction of the Y1 direction, so that dots corresponding to the image data Img are formed on the recording paper PP.

Hereinafter, the X1 direction and an X2 direction that is an opposite direction of the X1 direction will be collectively referred to as an “X axis direction,” the Y1 direction crossing the X axis direction and the Y2 direction that is the opposite direction of the Y1 direction will be collectively referred to as a “Y axis direction,” and a Z1 direction crossing the X axis direction and the Y axis direction and a Z2 direction that is an opposite direction of the Z1 direction will be collectively referred to as a “Z axis direction.” In this embodiment, as an example, a case where the X axis direction, the Y axis direction, and the Z axis direction are orthogonal to each other is assumed. However, the present disclosure is not limited thereto. The X axis direction, the Y axis direction, and the Z axis direction may cross each other. Note that, in this embodiment, the Z1 direction is a direction in which the ink is ejected from the ejection section D[m].

As illustrated in FIG. 4, the printing device 1 according to this embodiment includes a housing 100 and a carriage 110 configured to reciprocate in the Y axis direction in the housing 100 and on which the four head units 3 are mounted.

In this embodiment, as illustrated in FIG. 4 a case where the carriage 110 stores four ink cartridges 120 corresponding to inks of four colors, that is, cyan, magenta, yellow, and black, on a one-to-one basis is assumed. In this embodiment, as described above, a case where the printing device 1 includes the four head units 3 corresponding to the four ink cartridges 120 on a one-to-one basis is assumed. Each ejection section D[m] receives supply of the ink from one of the ink cartridges 120 corresponding to the head unit 3 in which the ejection section D[m] is provided. Thus, inside of each ejection section D[m] is filled with the supplied ink and the ejection section D[m] can eject the filling ink from a nozzle N. Note that the ink cartridges 120 may be provided outside the carriage 110.

As described above, the printing device 1 according to this embodiment includes the transport unit 7. As illustrated in FIG. 4 the transport unit 7 includes a carriage transport mechanism 71 that reciprocates the carriage 110 in the Y axis direction, a carriage guide shaft 76 that supports the carriage 110 reciprocably in the Y axis direction, a medium transport mechanism 73 that transports the recording paper PP, and a platen 75 provided in the Z1 direction of the carriage 110. Therefore, when print processing is executed, the transport unit 7 changes a relative position of the recording paper PP with respect to the head units 3 to allow ejection of the ink to entire recording paper PP by reciprocating the head units 3 with the carriage 110 in the Y axis direction along the carriage guide shaft 76 by the carriage transport mechanism 71 and transporting the recording paper PP on the platen 75 in the X1 direction by the medium transport mechanism 73.

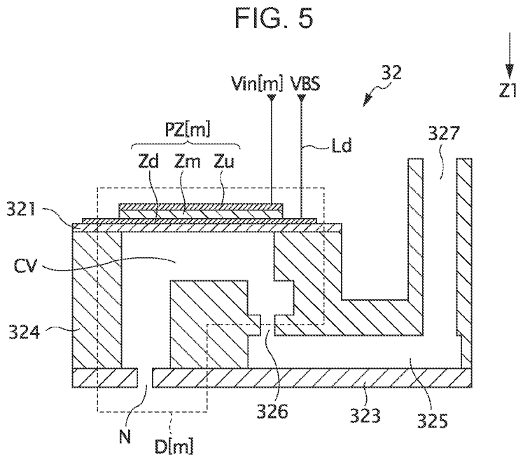

FIG. 5 is a schematic partial cross-sectional view of the recording head 32 obtained by cutting the recording head 32 such that a cross section includes the ejection section D[m].

As illustrated in FIG. 5, the ejection section D[m] includes a piezoelectric element PZ[m], a cavity CV inside of which is filled with an ink, a nozzle N that communicates with the cavity CV, and a vibration plate 321. The ejection section D[m] ejects the ink in the cavity CV from the nozzle N by driving the piezoelectric element PZ[m] by the supply driving signal Vin[m]. The cavity CV is a space defined by a cavity plate 324, a nozzle plate 323 in which the nozzle N is formed, and the vibration plate 321. The cavity CV communicates with a reservoir 325 via an ink supply port 326. The reservoir 325 communicates with the ink cartridge 120 corresponding to the ejection section D[m] via an ink inlet port 327. The piezoelectric element PZ[m] includes an upper electrode Zu[m], a lower electrode Zd[m], a piezoelectric body Zm[m] provided between the upper electrode Zu[m] and the lower electrode Zd[m]. The lower electrode Zd[m] is electrically coupled to a feeder line LD set to a potential VBS. Then, when the supply driving signal Vin[m] is supplied to the upper electrode Zu[m] and thus a voltage is applied between the upper electrode Zu[m] and the lower electrode Zd[m], the piezoelectric element PZ[m] is displaced in the Z1 direction or the Z2 direction in accordance with the applied voltage, so that the piezoelectric element PZ[m] vibrates. The lower electrode Zd[m] is joined to the vibration plate 321. Therefore, when the piezoelectric element PZ[m] is driven by the supply driving signal Vin[m] to vibrate, the vibration plate 321 also vibrates. A volume of the cavity CV and a pressure in the cavity CV change due to vibration of the vibration plate 321 and thus the ink with which the cavity CV is filled is ejected from the nozzle N.

### 3. Outline of Head Unit

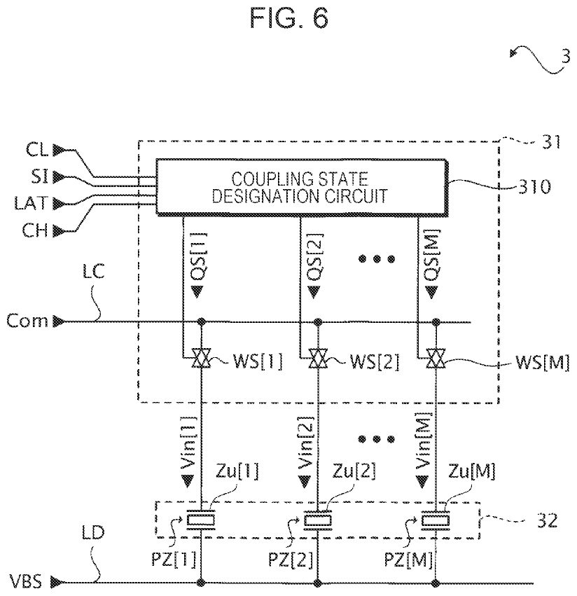

An outline of the head unit 3 will be described below with reference to FIG. 6 to FIG. 8.

FIG. 6 is a block diagram illustrating an example of a configuration of the head unit 3.

As illustrated in FIG. 6, the head unit 3 includes the supply circuit 31 and the recording head 32. The head unit 3 includes a wiring LC through which the driving signal Com is supplied from the driving unit 4.

As illustrated in FIG. 6, the supply circuit 31 includes M switches WS[1] to WS[M] corresponding to the M ejection sections D[1] to D[M] on a one-to-one basis and a coupling state designation circuit 310 that designates a coupling state of each switch.

The coupling state designation circuit 310 generates a coupling state designation signal QS[m] that designates on and off of a switch WS[m], based on at least some of the print signal SI, a latch signal LAT, and a change signal CH supplied from the control unit 2.

The switch WS[m] switches, based on the coupling state designation signal QS[m], between conduction and non-conduction between the wiring LC and the upper electrode Zu[m] of the piezoelectric element PZ[m] provided in the ejection section D[m]. In this embodiment, the switch WS[m] turns on when the coupling state designation signal QS[m] is at a high level and turns off when the coupling state designation signal QS[m] is at a low level. When the switch WS[m] turns on, the driving signal Com that is supplied to the wiring LC is supplied as the supply driving signal Vin[m] to the upper electrode Zu[m] of the ejection section D[m].

In this embodiment, when the printing device 1 executes print processing, as an operation period of the printing device 1, one or more unit periods TP are set. The printing device 1 according to this embodiment can drive each ejection section D[m] for the print processing in each unit period TP.

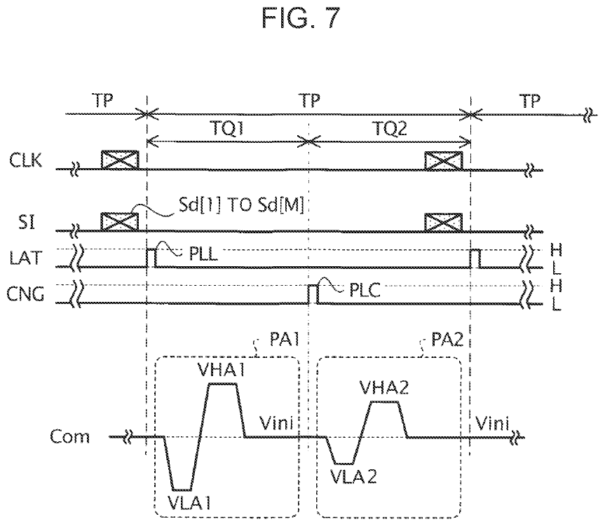

FIG. 7 is a timing chart illustrating various signals, such as the driving signal Com or the like, supplied to the head unit 3 in the unit period TP.

As illustrated in FIG. 7, the control unit 2 outputs the latch signal LAT having a pulse PLL. Thus, the control unit 2 defines the unit period TP as a period from a rise of a pulse PLL to a next rise of the pulse PLL.

The control unit 2 also outputs the change signal CH having a pulse PLC in the unit period TP. Then, the control unit 2 divides the unit period TP into a driving period TQ1 from the rise of the pulse PLL to a rise of the pulse PLC and a driving period TQ2 from the rise of the pulse PLC to a next rise of the pulse PLL.

As illustrated in FIG. 7, the print signal SI includes M individual designation signals Sd[1] to Sd[M] corresponding to the M ejection section D[1] to D[M] on a one-to-one basis. When the printing device 1 executes print processing, an individual designation signal Sd[m] designates a mode of driving of the ejection section D[m] in each unit period TP. Prior to each unit period TP, the control unit 2 supplies the print signal SI including the M individual designation signals Sd[1] to Sd[M] to the coupling state designation circuit 310 in synchronization with a clock signal CL. Then, the coupling state designation circuit 310 generates the coupling state designation signal QS[m], based on the individual designation signal Sd[m], in the unit period TP.

Note that, in this embodiment, a case where, in the unit period TP in which print processing is executed, the ejection section D[m] is configured to form the dots of any ones of large dots formed of ink of an ink amount ξ1, medium dots formed of ink of an ink amount ξ2 that is smaller than the ink amount ξ1, and small dots formed of ink of an ink amount ξ3 that is smaller than the ink amount ξ2 is assumed.

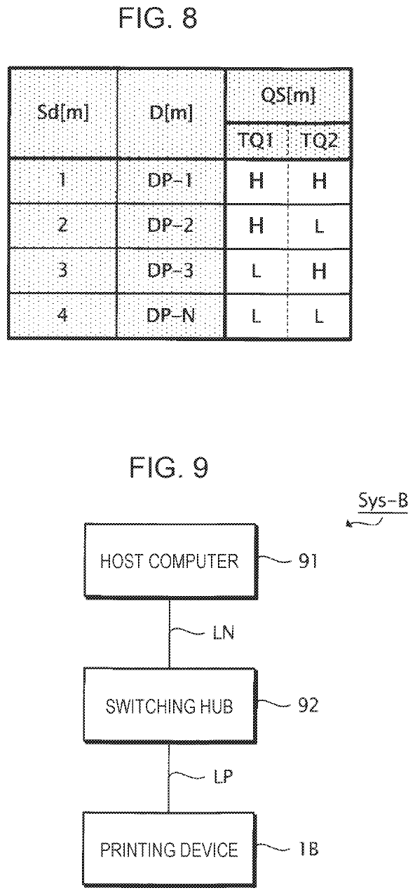

FIG. 8 is a table illustrating the individual designation signal Sd[m].

As illustrated in FIG. 8, in this embodiment, the individual designation signal Sd[m] can be any one of four values, that is, a value “1” that designates the ejection section D[m] as a large dot forming ejection section DP-1, a value “2” that designates the ejection section D[m] as a medium dot forming ejection section DP-2, a value “3” that designates the ejection section D[m] as a small dot forming ejection section DP-3, and a value “4” that designates the ejection section D[m] as a non-dot-forming ejection section DP-N in the unit period TP in which print processing is executed. Herein, the large dot forming ejection section DP-1 is an ejection section D that forms large dots in the unit period TP. The medium dot forming ejection section DP-2 is an ejection section D that forms medium dots in the unit period TP. The small dot forming ejection section DP-3 is an ejection section D that forms small dots in the unit period TP. The non-dot-forming ejection section DP-N is an ejection section D that does not form dots in the unit period TP.

Return to description of FIG. 7. As illustrated in FIG. 7, in this embodiment, the driving signal Com has a waveform PA1 provided in a driving period TQ1 and a waveform PA2 provided in a driving period TQ2.

Of the waveforms, the waveform PA1 is a waveform in which a potential changes from a reference potential Vini to a potential VLA1 that is lower than the reference potential Vini and a potential VHA1 that is higher than the reference potential Vini, and then, returns to the reference potential Vini. The waveform PA1 is determined such that, when the supply driving signal Vin[m] having the waveform PA1 is supplied to the ejection section D[m], ink corresponding to an ink amount Φ1 is ejected from the ejection section D[m]. The waveform PA2 is a waveform in which a potential changes from the reference potential Vini to a potential VLA2 that is lower than the reference potential Vini and a potential VHA2 that is higher than the reference potential Vini, and then, returns to the reference potential Vini. The waveform PA2 is determined such that, when the supply driving signal Vin[m] having the waveform PA2 is supplied to the ejection section D[m], ink corresponding to an ink amount Φ2 is ejected from the ejection section D[m].

Note that, in this embodiment, a case where the ink amount ξ1 corresponds to a sum of the ink amount Φ1 and the ink amount Φ2, the ink amount ξ2 corresponds to the ink amount Φ1, and the ink amount ξ3 corresponds to the ink amount Φ2 is assumed.

In this embodiment, as an example, a case where, when a potential of the supply driving signal Vin[m] supplied to the ejection section D[m] is high, the volume of the cavity CV of the ejection section D[m] is smaller than that when the potential is low is assumed. Therefore, when the ejection section D[m] is driven by the supply driving signal Vin[m] having the waveform PA1 or the like, the potential of the supply driving signal Vin[m] changes from a low potential to a high potential, so that the ink in the ejection section D[m] is ejected from the nozzle N.

As illustrated in FIG. 8, when the individual designation signal Sd[m] represents the value “1” that designates the ejection section D[m] as the large dot forming ejection section DP-1 in the unit period TP, the coupling state designation circuit 310 sets the coupling state designation signal QS[m] to a high level in the driving period TQ1 and the driving period TQ2. In this case, the switch WS[m] turns on in the driving period TQ1 and the driving period TQ2. Therefore, the ejection section D[m] is driven by the supply driving signal Vin[m] having the waveform PA1 and the waveform PA2 to eject ink of the ink amount ξ1 corresponding to large dots in the unit period TP.

When the individual designation signal Sd[m] represents the value “2” that designates the ejection section D[m] as the medium dot forming ejection section DP-2 in the unit period TP, the coupling state designation circuit 310 sets the coupling state designation signal QS[m] to a high level in the driving period TQ1, and in this case, the switch WS[m] turns on in the driving period TQ1. Therefore, the ejection section D[m] is driven by the supply driving signal Vin[m] having the waveform PA1 to eject ink of the ink amount ξ2 corresponding to medium dots in the unit period TP.

When the individual designation signal Sd[m] represents the value “3” that designates the ejection section D[m] as the small dot forming ejection section DP-3 in the unit period TP, the coupling state designation circuit 310 sets the coupling state designation signal QS[m] to a high level in the driving period TQ2. In this case, the switch WS[m] turns on in the driving period TQ2. Therefore, the ejection section D[m] is driven by the supply driving signal Vin[m] having the waveform PA2 to eject ink of the ink amount ξ3 corresponding to small dots in the unit period TP.

When the individual designation signal Sd[m] represents the value “4” that designates the ejection section D[m] as the non-dot-forming ejection section DP-N in the unit period TP, the coupling state designation circuit 310 sets the coupling state designation signal QS[m] to a low level throughout the unit period TP. In this case, the switch WS[m] is off throughout the unit period TP. Therefore, the ejection section D[m] is not driven by the supply driving signal Vin[m] in unit period TP, so that the ejection section D[m] does not eject an ink.

### 4. Conclusion of Embodiment

As has been described above, the printing device 1 according to this embodiment includes the Ethernet coupling section 81 to which the cable LP configured to transmit information and transmit electric power is coupled and the print processing execution section 10 that executes print processing of forming an image based on the image data Img supplied from the cable LP on the recording paper PP using the electric power PW0 supplied from the cable LP.

That is, according to this embodiment, a power supply wiring used for supplying necessary electric power for executing print processing to the printing device 1 and an information supply wiring used for supplying necessary information for executing print processing to the printing device 1 can be integrated into the cable LP. Therefore, according to this embodiment, as compared to a mode in which two wirings, that is, a power supply wiring and an information supply wiring, are coupled to the printing device 1, the number of wirings coupled to the printing device 1 can be reduced.

The printing device 1 according to this embodiment may include the power supply unit 5 that is charged with the electric power PW0 supplied from the cable LP, and the print processing execution section 10 may be configured to execute print processing using the electric power PW1 and the electric power PW2 supplied from the power supply unit 5.

Thus, according to this embodiment, even in a state where the cable LP is removed from the printing device 1 and the printing device 1 cannot receive supply of electric power via the cable LP, print processing can be executed.

The printing device 1 according to this embodiment may include the power supply unit 5 that is charged with the electric power PW0 supplied from the cable LP and the USB coupling section 82 to which the cable LB configured to transmit information and transmit electric power are coupled, the print processing execution section 10 may be configured to execute print processing using the electric power PW1 and the electric power PW2 supplied from the power supply unit 5, and the power supply unit 5 may be configured to supply the electric power PW3 to the external device 93 coupled via the cable LB via the cable LB.

Thus, according to this embodiment, transmission of information and transmission of electric power to the external device 93 via the cable LB are enabled, and therefore, as compared to a mode in which two wirings, that is, a power supply wiring and an information supply wiring, are coupled to the external device 93, the number of wirings coupled to the external device 93 can be reduced.

In the printing device 1 according to this embodiment, the print processing execution section 10 may be configured to execute print processing in a state where no cable other than the cable LP is coupled to the printing device 1.

Therefore, according to this embodiment, as compared to a mode in which two wirings, that is, a power supply wiring and an information supply wiring, are coupled to the printing device 1, the number of wirings coupled to the printing device 1 can be reduced.

The printing device 1 according to this embodiment may include the power supply unit 5 that is charged with the electric power PW0 supplied from the cable LP and the USB coupling section 82 to which the cable LB configured to transmit information and transmit electric power are coupled, the print processing execution section 10 may include the head unit 3 that forms an image based on the image data Img supplied from the cable LP on the recording paper PP, and the control unit 2 that controls the head unit 3, based on the image data Img supplied from the cable LP, the power supply unit 5 may be configured to supply the electric power PW3 to the external device 93 coupled via the cable LB via the cable LB, and the control unit 2 may be configured to control the external device 93 via the cable LB.

Therefore, according to this embodiment, transmission of information and transmission of electric power to the external device 93 via the cable LB are enabled, and therefore, as compared to a mode in which two wirings, that is, a power supply wiring and an information supply wiring, are coupled to the external device 93, the number of wirings coupled to the external device 93 can be reduced.

The printing device 1 according to this embodiment may include the power supply unit 5 that is charged with the electric power PW0 supplied from the cable LP and the USB coupling section 82 to which the cable LB configured to transmit information and transmit electric power are coupled, the print processing execution section 10 may include the head unit 3 that forms an image based on the image data Img supplied from the cable LP on the recording paper PP, and the control unit 2 that controls the head unit 3, based on the image data Img supplied from the cable LP, the power supply unit 5 may be configured to supply the electric power PW3 to the external device 93 coupled via the cable LB via the cable LB, and the control unit 2 may be configured to output the transmission information DBs acquired from the external device 93 via the cable LB as the transmission information DPs to the cable LP.

Therefore, according to this embodiment, transmission of information and transmission of electric power to the external device 93 via the cable LB are enabled, and therefore, as compared to a mode in which two wirings, that is, a power supply wiring and an information supply wiring, are coupled to the external device 93, the number of wirings coupled to the external device 93 can be reduced.

The printing device 1 according to this embodiment may include the power supply unit 5 that is charged with the power PW0 supplied from the cable LP and the USB coupling section 82 to which the cable LB configured to transmit information and transmit power are coupled, the print processing execution section 10 may include the head unit 3 that forms an image based on the image data Img supplied from the cable LP on the recording paper PP and the control unit 2 that controls the head unit 3, based on the image data Img supplied from the cable LP, the power supply unit 5 may be configured to supply the power PW3 to the external device 93 coupled via the cable LB via the cable LB, and the control unit 2 may be configured to adjust the magnitude of the power PW3 supplied to the external device 93 from the power supply unit 5 in accordance with the external device 93.

Therefore, according to this embodiment, the power supply unit 5 can supply the power PW3 of an appropriate amount of power for driving the external device 93 via the cable LB.

In the printing device 1 according to this embodiment, the cable LP may be a cable conforming to an Ethernet standard.

That is, according to this embodiment, the cable LP is a cable conforming to an Ethernet standard in which a distance from a power supply source to a power supply destination is limited to about 100 m, and therefore, the power supply source, such as the switching hub 92 or the like, and the printing device 1 can be separated from each other with a distance of about 100 m therebetween. Accordingly, as compared to a mode in which the cable LP is a cable conforming to a USB standard in which a distance from a power supply source to a power supply destination is limited to about 5 m, a degree of freedom of installation of the printing device 1 can be increased.

### B. Modified Examples

Each embodiment described above may be variously modified. Specific modes of modification will be exemplified below. Two or more modes arbitrarily selected from the following examples can be appropriately combined with each other in a range in which they do not mutually contradict each other. Note that, in modified examples described below, for elements having equivalent effects and functions to those of the embodiment, the reference sings that are referred to in the description given above are reused and the detailed description of each of the elements will be omitted, as appropriate.

### First Modified Example

In the above-described embodiment, a mode in which the printing system Sys includes the external device 93 has been described, but the present disclosure is not limited thereto. The printing system Sys may be configured without external device 93.

FIG. 9 is a functional block diagram illustrating an example of a configuration of a printing system Sys-B according to this modified example.

As illustrated in FIG. 9, the printing system Sys-B is different from the printing system Sys according to the above-described embodiment in a point that the printing system Sys-B includes, instead of the printing device 1, a printing device 1B and a point that the printing system Sys-B does not include the external device 93 and the cable LB.

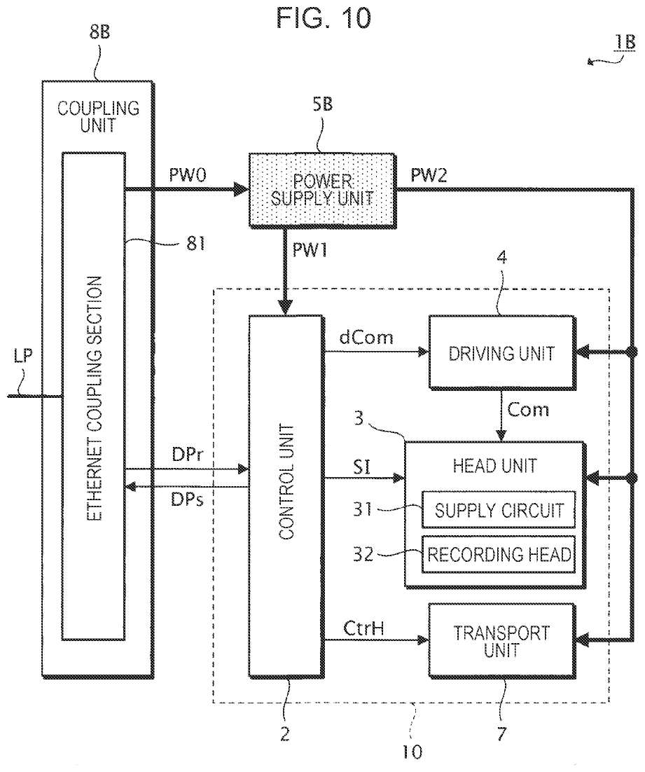

FIG. 10 is a functional block diagram illustrating an example of a configuration of the printing device 1B.

As illustrated in FIG. 10, the printing device 1B is different from the printing device 1 according to the above-described embodiment in a point that the printing device 1B includes, instead of the power supply unit 5, a power supply unit 5B and a point that the printing device 1B includes, instead of the coupling unit 8, a coupling unit 8B. In this connection, the coupling unit 8B is different from the coupling unit 8 according to the above-described embodiment in a point that the coupling unit 8B does not include the USB coupling section 82. In this modified example, the printing device 1B includes the coupling unit 8B, but the printing device 1B may include the coupling unit 8.

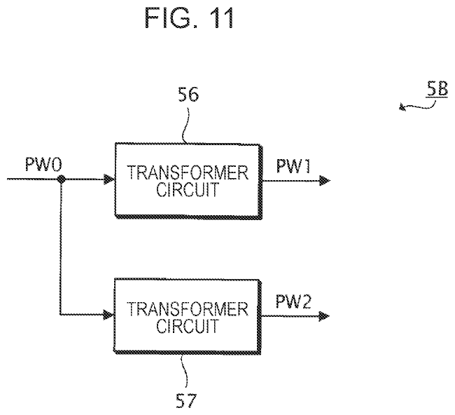

FIG. 11 is a functional block diagram illustrating an example of a configuration of the power supply unit 5B.

As illustrated in FIG. 11, the power supply unit 5B includes a transformer circuit 56 and a transformer circuit 57. Of the transformer circuit 56 and the transformer circuit 57, the transformer circuit 56 converts the voltage V0 of the power PW0 supplied from the cable LP via the Ethernet coupling section 81 to the voltage V1 and outputs the power PW1 of the voltage V1. The power PW1 output from the transformer circuit 56 is supplied to the control unit 2. The transformer circuit 57 converts the voltage V0 of the power PW0 supplied from the cable LP via the Ethernet coupling section 81 to the voltage V2 and outputs the power PW2 of the voltage V2. The power PW2 output from the transformer circuit 57 is supplied to the head unit 3, the driving unit 4, and the transport unit 7.

As described above, also in this modified example, similar to the above-described embodiment, a power supply wiring used for supplying necessary electric power for executing print processing to the printing device 1B and an information supply wiring used for supplying necessary information for executing the print processing to the printing device 1B can be integrated into the cable LP. Therefore, according to this modified example, as compared to a mode in which two wirings, that is, a power supply wiring and an information supply wiring, are coupled to the printing device 1B, the number of wirings coupled to the printing device 1B can be reduced.

### Second Modified Example

In the above-described embodiment and the first modified example, a case where the printing device 1 includes four head units 3 is assumed, but the present disclosure is not limited thereto. The printing device 1 may include one or more and three or less head units 3, and moreover, the printing device 1 may include five or more head units 3.

### Third Modified Example

In the above-described embodiment and the first and second modified examples, a case where the printing device 1 is a serial printer has been described as an example, but the present disclosure is not limited thereto. The printing device 1 may be a so-called line printer in which, in the head unit 3, a plurality of nozzles N are provided so as to extend to be wider than the width of the recording paper PP.

### Fourth Modified Example

In the above-described embodiment and the first, second and third modified examples, the printing device 1 is described using as an example a so-called piezoelectric inkjet printer in which the piezoelectric element PZ[m] is vibrated to change the pressure in the cavity CV, so that the ink in the cavity CV is ejected from the nozzle N, but the present disclosure is not limited thereto. For example, a so-called thermal inkjet printer in which a heat generating element provided in the cavity CV is heated to generate bubbles in the cavity CV to change the pressure in the cavity CV, so that the ink in the cavity CV is ejected from the nozzle N may be employed as the printing device 1.

1. A printing device comprising:
a first coupling section to which a first cable configured to transmit information and transmit electric power is coupled; and
a printing section that executes print processing of forming an image based on information supplied from the first cable on a medium using electric power supplied from the first cable.

2. The printing device according to claim 1, further comprising:
a power storage section that is charged with the electric power supplied from the first cable,
wherein
the printing section executes the print processing using electric power supplied from the power storage section.

3. The printing device according to claim 1, further comprising:
a power storage section that is charged with the electric power supplied from the first cable; and
a second coupling section to which a second cable configured to transmit information and transmit electric power is coupled,
wherein
the printing section executes the print processing using electric power supplied from the power storage section, and
the power storage section supplies electric power to an external device coupled via the second cable via the second cable.

4. The printing device according to claim 1, wherein
the printing section is configured to execute the print processing in a state where no cable other than the first cable is coupled to the printing device.

5. The printing device according to claim 1, further comprising:
a power storage section that is charged with the electric power supplied from the first cable; and
a second coupling section to which a second cable configured to transmit information and transmit electric power is coupled,
wherein
the printing device includes
an image forming section that forms an image based on the information supplied from the first cable on the medium, and
a control section that controls the image forming section, based on the information supplied from the first cable, and
the power storage section supplies electric power to an external device coupled via the second cable via the second cable, and
the control section controls the external device via the second cable.

6. The printing device according to claim 1, further comprising:
a power storage section that is charged with the electric power supplied from the first cable; and
a second coupling section to which a second cable configured to transmit information and transmit electric power is coupled,
wherein
the printing section includes
an image forming section that forms an image based on the information supplied from the first cable on the medium, and
a control section that controls the image forming section, based on the information supplied from the first cable, and
the power storage section supplies electric power to an external device coupled via the second cable via the second cable, and
the control section outputs information acquired from the external device via the second cable to the first cable.

7. The printing device according to claim 1, further comprising:
a power storage section that is charged with the electric power supplied from the first cable; and
a second coupling section to which a second cable configured to transmit information and transmit electric power is coupled,
wherein
the printing device includes
an image forming section that forms an image based on the information supplied from the first cable on the medium, and
a control section that controls the image forming section, based on the information supplied from the first cable, and
the power storage section supplies electric power to an external device coupled via the second cable via the second cable, and
the control section adjusts an amount of electric power supplied to the external device from the power storage section in accordance with the external device.

8. The printing device according to claim 1, wherein
the first is a cable conforming to an Ethernet standard.

9. A printing system, comprising:
a printing device including
a first coupling section to which a first cable configured to transmit information and transmit electric power is coupled,
a second coupling section to which a second cable configured to transmit information and transmit electric power is coupled, and
a printing section that executes print processing of forming an image based on information supplied from the first cable on a medium using electric power supplied from the first cable; and
an external device that is coupled to the printing device via the second cable, wherein
the printing device supplies electric power to the external device via the second cable.

10. The printing system according to claim 9, wherein
the printing device includes
a power storage section that is charged with the electric power supplied from the first cable, and
the printing section executes the print processing using electric power supplied from the power storage section.

11. The printing system according to claim 9, wherein
the printing section is configured to execute the print processing in a state where no cable other than the first cable is coupled to the printing device.

12. The printing system according to claim 9, wherein
the printing device includes
a power storage section that is charged with the electric power supplied from the first cable, and
the printing section includes
an image forming section that forms an image based on the information supplied from the first cable on the medium, and
a control section that controls the image forming section, based on the information supplied from the first cable, and
the power storage section supplies electric power to the external device via the second cable, and
the control section controls the external device via the second cable.

13. The printing system according to claim 9, wherein
the printing device includes
a power storage section that is charged with the electric power supplied from the first cable, and
the printing device includes
an image forming section that forms an image based on the information supplied from the first cable on the medium, and
a control section that controls the image forming section, based on the information supplied from the first cable,
the power storage section supplies electric power to the external device via the second cable, and
the control section outputs information acquired from the external device via the second cable to the first cable.

14. The printing system according to claim 9, wherein
the printing device includes
a power storage section that is charged with the electric power supplied from the first cable, and
the printing device includes
an image forming section that forms an image based on the information supplied from the first cable on the medium, and
a control section that controls the image forming section, based on the information supplied from the first cable,
the power storage section supplies electric power to the external device via the second cable, and
the control section adjusts an amount of electric power supplied to the external device from the power storage section in accordance with the external device.

15. The printing system according to claim 9, wherein
the first is a cable conforming to an Ethernet standard.
